(19) United States
(12) Patent Application Publication
(10) Pub. No.: US 2017/0351336 A1
(43) Pub. Date: Dec. 7, 2017

(54) TIME OF FLIGHT BASED GESTURE CONTROL DEVICES, SYSTEMS AND METHODS

(71) Applicant: STMicroelectronics, Inc., Coppell, TX (US)

(72) Inventors: Xiaoyong Yang, San Jose, CA (US); Darin K. Winterton, San Jose, CA (US)

(21) Appl. No.: 15/616,602

(22) Filed: Jun. 7, 2017

Related U.S. Application Data
(60) Provisional application No. 62/346,993, filed on Jun. 7, 2016.

(51) Int. Cl. G06F 3/01; G06F 3/041; H04N 5/232; G06F 3/03; G06F 3/0488; H04N 5/225; H04N 5/247; H04W 88/02

(52) U.S. Cl. CPC G06F 3/017; H04N 5/2256; G06F 3/0416; H04N 5/247; H04N 5/23216; H04N 5/23212; G06F 3/0304; G06F 3/04883; G06F 2203/04108; H04W 88/02

(57) ABSTRACT

A device includes a time-of-flight sensor configured to transmit an optical pulse signal and to receive a return optical pulse signal corresponding to a portion of the transmitted optical pulse signal that has reflected off an object within a field of view of the time-of-flight sensor. The time-of-flight sensor generates a range estimation signal including a distance to the object and a signal amplitude indicating an amplitude of the return optical pulse signal. A controller is coupled to the time of flight sensor and is configured to process the range estimation signal over time to detect an input gesture based upon the signal amplitude and estimated distance.

### BACKGROUND

### Technical Field

The present disclosure relates generally to gesture control of electronic devices such as smartphones, and more specifically to time of flight based gesture detection and control.

### Description of the Related Art

In mobile devices such as smart phones a touch screen or touch panel is utilized to control the operation of the mobile device, along with buttons typically contained on the mobile device. Similarly, wearable devices are typically controlled through a touch panel, and may also include buttons on the device. In some situations, the utilization of a touch panel may be problematic. For example, a wearable device may have a relatively small display requiring a correspondingly small touch panel, making it difficult for at least some persons to easily control the device by touching desired portions of the touch panel. Similarly, in mobile devices such as smart phones, when taking a selfie (i.e., extending the phone away from one's face and taking a picture of oneself) it may be difficult for the person taking the selfie to control the operation of the smart phone to take the picture. For example, the button on the touch panel may make it difficult for some users to hold the smart phone in one hand and press the button with a finger of that same hand. As a result, the person may need to use their second hand to take the picture, which can undesirably bring the phone closer to the person's face making it more difficult to take the desired selfie picture. There is a need for improved control of mobile devices like as smart phones as well as other types of electronic devices such as wearable devices.

### BRIEF SUMMARY

In one embodiment of the present disclosure, a device includes a time-of-flight sensor configured to transmit an optical pulse signal and to receive a return optical pulse signal corresponding to a portion of the transmitted optical pulse signal that has reflected off an object within a field of view of the time-of-flight sensor. The time-of-flight generates a range estimation signal including an estimated distance to the object and a signal amplitude indicating an amplitude of the return optical pulse signal. A controller is coupled to the time of flight sensor and is configured to process the range estimation signal over time to detect an input gesture based upon the signal amplitude and estimated distance. In an embodiment, the device includes a front side and a back side opposite the front side, and the time-of-flight sensor is positioned on the back side to detect input gestures provided on the back side of the device.

### BRIEF DESCRIPTION OF THE SEVERAL VIEWS OF THE DRAWINGS

The foregoing and other features and advantages will become apparent from the following detailed description of embodiments, given by way of illustration and not limitation with reference to the accompanying drawings, in which:

FIG. 1 is a functional block diagram of an electronic device including a time-of-flight sensor for detecting input gestures to control operation of the electronic device according to one embodiment of the present disclosure.

FIG. 2 is a functional diagram illustrating the operation of the time-of-flight sensor of FIG. 1.

FIG. 3 is a functional block diagram illustrating in more detail one embodiment of the time-of-flight sensor of FIGS. 1 and 2.

FIGS. 4A and 4B show the time-of-flight sensor of FIG. 1 positioned on the back side and along a front edge of electronic devices according to embodiments of the present disclosure.

FIGS. 5A and 5B illustrate a finger of a user providing an input gesture to the time-of-flight sensors in the embodiments of FIGS. 4A and 4B, respectively.

FIG. 6A is a perspective view of an electronic device illustrating a frame of reference relative to a time-of-flight sensor contained in the device.

FIG. 6B illustrates how the range estimation signal provided by the time-of-flight sensor of FIGS. 1-3 enables the sensing of different types of input gestures according to embodiments of the present disclosure.

FIGS. 7A-7D illustrate the concept of multiple fields of view or zones utilized in some embodiment of the time-of-flight sensor of FIGS. 1-3 to sense some of types of input gestures.

### DETAILED DESCRIPTION

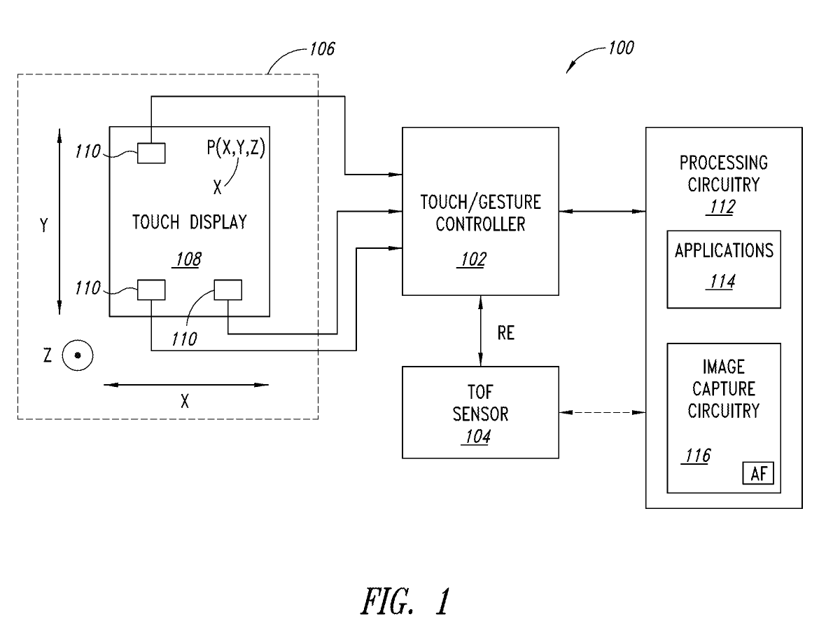

FIG. 1 is a functional block diagram of an electronic device 100 including a touch/gesture controller 102 and a time-of-flight sensor 104 operable to detect input gestures and to control the electronic device based on the detected input gestures according to one embodiment of the present disclosure. The time-of-flight sensor 104 utilizes time-of-flight based sensing to transmit an optical pulse that is then reflected off an object within a field of view of the sensor and a portion of which returns to the sensor in the form a return optical pulse. A time-to-digital converter, time-to-analog converter or other suitable circuitry in the time-of-flight sensor 104 detects a time-of-flight of the optical pulse and in this way determines a distance to the object, as will be appreciated by those skilled in the art and as will be described in more detail below.

The time-of-flight sensor 104 generates a range estimation signal RE that provides a sensed distance D_{TOF} to an object as well as providing signal strength or amplitude SA information for the return optical pulse. Based on the signal amplitude SA and sensed distance D_{TOF} information provided by the range estimation signal RE signal over time, the touch/gesture controller 102 detects various types of input gestures provided to the electronic device 100 by a user (not shown), and the electronic device is controlled in response to these detected input gestures, as will be described in more detail below.

In the present description, certain details are set forth in conjunction with the described embodiments to provide a sufficient understanding of the present disclosure. One skilled in the art will appreciate, however, that the other embodiments may be practiced without these particular details. Furthermore, one skilled in the art will appreciate that the example embodiments described below do not limit the scope of the present disclosure, and will also understand that various modifications, equivalents, and combinations of the disclosed embodiments and components of such embodiments are within the scope of the present disclosure. Embodiments including fewer than all the components of any of the respective described embodiments may also be within the scope of the present disclosure although not expressly described in detail below. Finally, the operation of well-known components and/or processes has not been shown or described in detail below to avoid unnecessarily obscuring the present disclosure.

The electronic device 100 further includes a touch screen 106 containing a touch display 108, such as a liquid crystal display, and a touch panel including a number of touch sensors 110 positioned on the touch display to detect touch points P(X,Y,Z), with only three touch sensors being shown merely by way of example and to simplify the figure. There are typically many more touch sensors 110. These touch sensors 110 are usually contained in a transparent sensor array that is then mounted on a surface of the touch display 108. The number and locations of the touch sensors 110 can vary as can the particular technology or type of sensor, with typical sensors being resistive, vibration, capacitive, or ultrasonic sensors. In the embodiments described herein, the sensors are considered to be capacitive sensors by way of example. In operation of the touch screen 106, a user generates a touch point P(X,Y,Z) through a suitable interface input, such as a touch event, hover event, or gesture event. In response to a touch point P(X,Y,Z), the sensors 110 generate respective signals that are provided to the gesture controller 102 which, in turn, processes these signals to generate touch information for the corresponding touch point. Thus, in the example embodiment of FIG. 1 the touch/gesture controller 102 processes signals from touch sensors 110 to sense touch, hover and gesture events through the touch screen 106 and also processes the range estimation signal RE to detect input gestures through the time-of-flight sensor 104.

The electronic device 100 also includes processing circuitry 112 coupled to the touch/gesture controller 102 to receive from the touch/gesture controller 102 the generated touch information, including the location of the touch point P(X,Y,Z) and the corresponding type of detected interface input (e.g., touch event, hover event, or gesture event) associated with the touch point. The touch/gesture controller 102 also provides to the processing circuitry 112 gesture information for input gestures sensed through the time-of-flight sensor 104, as described in more detail below. The processing circuitry 112 executes applications or “apps” 114 that control the electronic device 100 to implement desired functions or perform desired tasks. These apps 114 executing on the processing circuitry 112 interface with a user of electronic device 110 through the controller 102 and touch screen 106, allowing a user to start execution of or “open” one of the apps 114 and thereafter interface with the app through the touch display 108 or through the time-of-flight sensor 104.

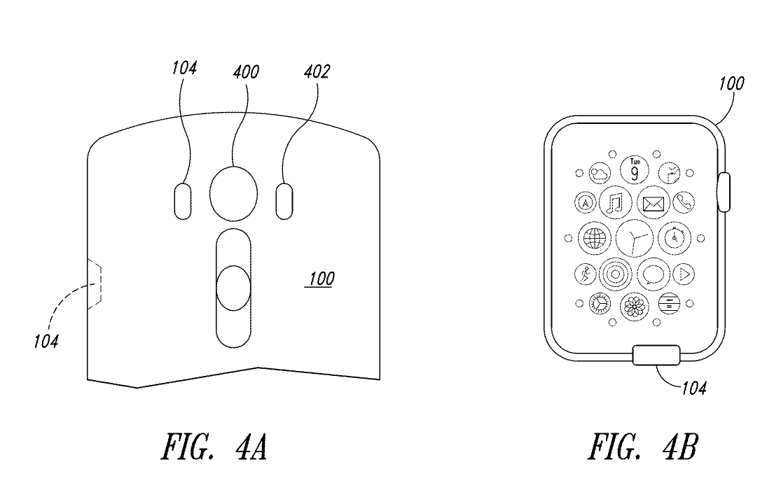

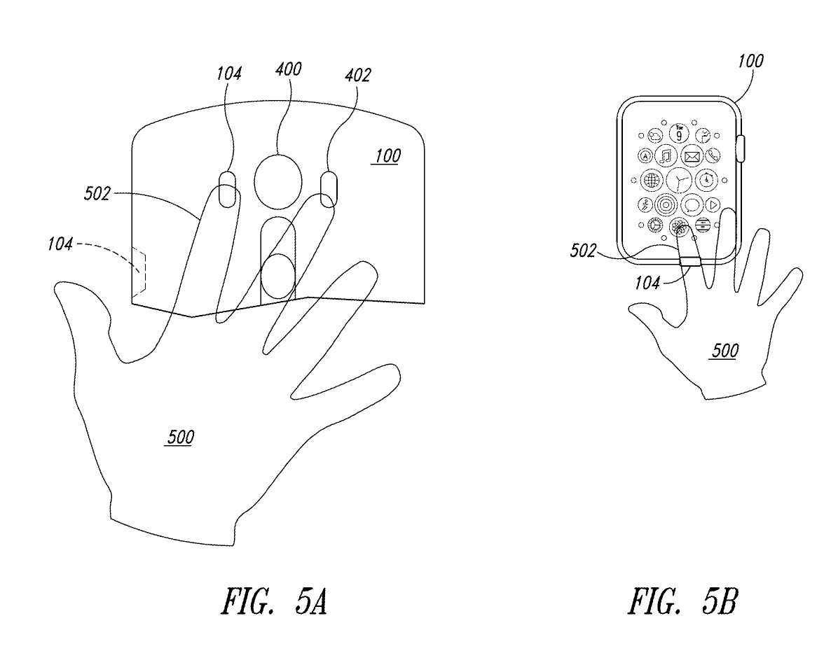

The processing circuitry 112 generally represents different types of circuitry that may be contained in the electronic device 100. For example, where the electronic device 100 is a mobile device such as a smart phone, the processing circuitry 112 would typically include communications circuitry like mobile telecommunications circuitry and Wi-Fi circuitry, along with power management circuitry, input/output circuitry, and so on. Image capture circuitry 116, which would typically include a digital camera to capture still and video images, is shown as being part of the processing circuitry 112 in the embodiment of FIG. 1. This image capture circuitry 116 includes an autofocus subsystem AF that can use the estimated distance D_{TOF} sensed by the time-of-flight sensor 104 to an object being imaged to focus the image capture circuitry on the object. Where the electronic device 100 is a smart phone, the image capture circuitry 116 is typically able to capture images from a front side of the smart phone, which is the side on which the touch screen 106 positioned, as well as from the back side of the smart phone, as will be discussed in more detail below with reference to the embodiment of FIGS. 4A and 5A.

In one embodiment, the time-of-flight sensor 104 is an existing sensor contained in the electronic device 100 that is utilized by the autofocus subsystem AF when the image capture circuitry is active (i.e., being used to capture still or video images). When the image capture circuitry 116 is inactive (i.e., not being used to capture still or video images) the time-of-flight sensor 104 in conventional electronic devices is typically deactivated. In the electronic device 100, when the image capture circuitry 116 is inactive the time-of-flight sensor 104 is used for detecting input gestures, as will be described in more detail below.

The time-of-flight sensor 104 is positioned on the electronic device 104 to detect a particular type or types of input gestures provided to the electronic device 100. For example, in one embodiment the electronic device 100 is a smart phone and the time-of-flight sensor 104 is positioned on a back side of the smart phone opposite a front side containing the touch screen 106. Thus, in addition to detecting touch events on the touch screen 106, the touch/gesture controller 102 processes the range estimation signal RE from the time-of-flight sensor 104 over time to detect input gestures provided by a user on a back side of the electronic device 100. The touch/gesture controller 102 then provides information about the input gesture detected through the range estimation signal RE in the information provided to the processing circuitry 112 which, in turn, controls the operation of the electronic device 100 based on the detected input gestures, as will be described in more detail below.

Although the time-of-flight sensor 104 is shown as being coupled to the touch/gesture controller 102, the time-of-flight sensor could alternatively be coupled directly to the processing circuitry 112, as indicated through the dashed line in FIG. 1. In this situation, the processing circuitry 112 would process the range estimation signal RE over time to generate detected input gestures as described above for the touch/gesture controller 102. Thus, control circuitry for processing the range estimation signal RE or signals from the time-of-flight sensor 104 over time may be contained or implemented in either the touch/gesture controller 102 or the processing circuitry 112, or in both.

Where the electronic device 100 is a smart phone or other mobile electronic device, the time-of-flight sensor 104 may already be contained in the smart phone for use in performing auto focus operations for image capture circuitry 116 contained in the electronic device, and thus an existing time-of-flight sensor already contained in the smart may be used in embodiments of the present disclosure. Existing time-of-flight sensors contained in image capture circuitry 116 of electronic devices are only activated and utilized when this image capture circuitry is being utilized. As a result, these existing time-of-flight sensors may be utilized for input gesture recognition according to embodiments of the present disclosure when the sensor is not being utilized to perform autofocusing of the image capture circuitry 116 or not performing other distance related sense functions. The existing time-of-flight sensor could also be utilized in situations where the image capture circuitry 116 is being utilized but the time-of-flight sensor is not being utilized to perform autofocusing, such as where the image capture circuitry is being used to take a selfie of the user. Some image capture systems include a rear facing camera and a front facing camera to accommodate taking a variety of images.

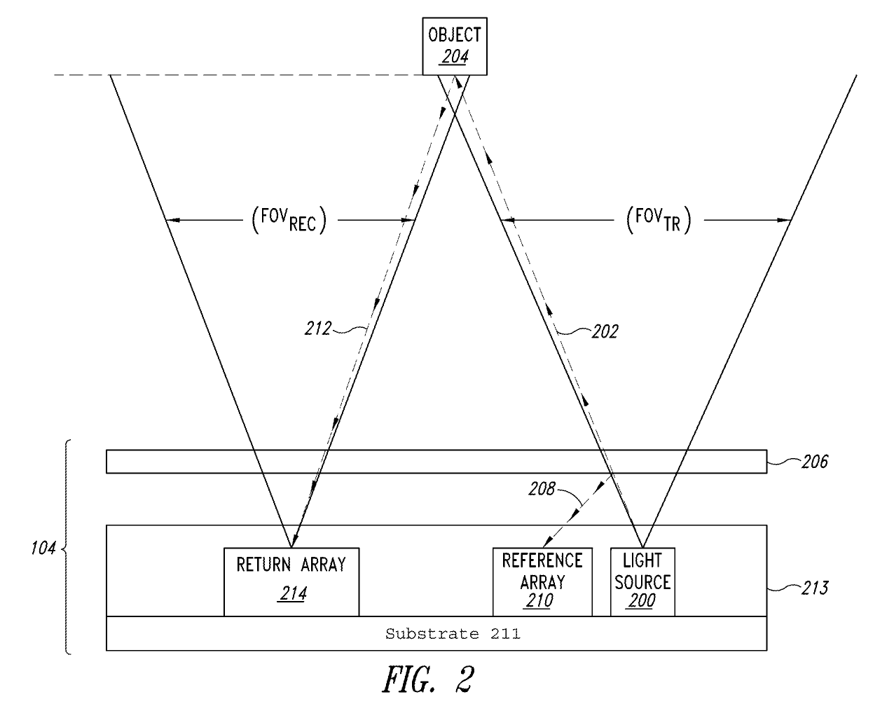

FIG. 2 is a functional diagram illustrating components and operation of the time-of-flight sensor 104 of FIG. 1. The time-of-flight sensor 104 may be a single chip that includes a light source 200 and a return and reference array of photodiodes 214, 210. Alternatively, these components may be incorporated within a camera module or other chip within the electronic device 100. The light source 200 and the return and reference arrays 214, 210 are on a substrate 211. In one embodiment, the touch/gesture controller 102 only includes circuitry for generating the range estimation signal RE and the time-of-flight sensor 102 and controller are contained in the same chip or package, and may be formed in the same integrated circuit within this package.

The light source 200 transmits optical pulse signals having a transmission field of view FOV_{TR} to irradiate objects within the field of view. A transmitted optical pulse signal 202 is illustrated in FIG. 2 as a dashed line and irradiates an object 204 within the transmission field of view FOV_{TR} of the light source 200. In addition, a reflected portion 208 of the transmitted optical pulse signal 202 reflects off an integrated panel, which may be within a package 213 or may be on a cover 206 of the electronic device. The reflected portion 208 of the transmitted pulse is illustrated as reflecting off the cover 206, however, it may be reflected internally within the package 213.

The cover 206 maybe be glass, such as on a front of a mobile device associated with a touch panel or the cover may be metal or another material that forms a back cover of the electronic device. The cover will include openings to allow the transmitted and return signals to be transmitted and received through the cover if not a transparent material.

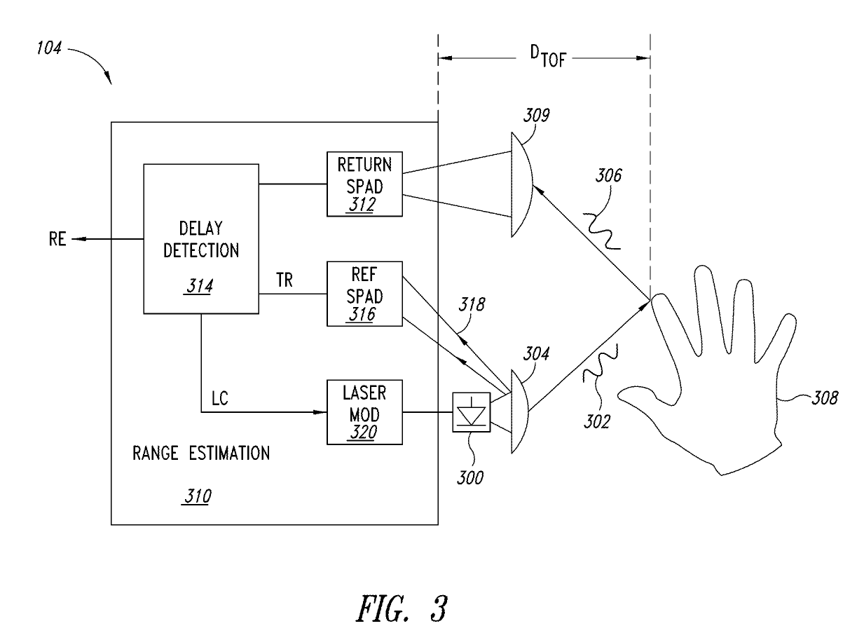

The reference array 210 of light sensors detects this reflected portion 208 to thereby sense transmission of the optical pulse signal 208. A portion of the transmitted optical pulse signal 202 reflects off the object 204 as a return optical pulse signal 212 that propagates back to the time-of-flight sensor 104. More specifically, the time-of-flight sensor 104 includes a return array 214 of light sensors having a receiving field of view FOV_{REC} that detects the return optical pulse signal 212. The time-of-flight sensor 104 then determines a distance D_{TOF} (FIG. 3) between the time-of-flight sensor and the object 204 based upon the time between the reference array 210 sensing transmission of the optical pulse signal 202 and the return array 214 sensing the return optical pulse signal 212.

Before describing further embodiments of the present disclosure, the time-of-flight sensor 104 will first be discussed with reference to FIG. 3, which is a more detailed functional block diagram of the time-of-flight sensor of FIGS. 1 and 2 according to one embodiment of the present disclosure. In the embodiment of FIG. 3, the time-of-flight sensor 104 includes a light source 300, which is, for example, a laser diode such as a vertical-cavity surface-emitting laser (VCSEL) for generating the transmitted optical pulse signal designated as 302 in FIG. 3. The transmitted optical pulse signal 302 is transmitted in the transmission field of view FOV_{TR} of the light source 300 as discussed above with reference to FIG. 2. In the embodiment of FIG. 3, the transmitted optical pulse signal 302 is transmitted through a projection lens 304 to focus the transmitted optical pulse signals 302 so as to provide the desired field of view FOV_{TR}. The projection lens 304 can be used to control the transmitted field of view FOV_{TR} of the sensor 104 and is an optional component, with some embodiments of the sensor not including the projection lens.

The reflected or return optical pulse signal is designated as 306 in the figure and corresponds to a portion of the transmitted optical pulse signal 302 that is reflected off an object, which is a hand 308 in FIG. 3. The return optical pulse signal 306 propagates back to the time-of-flight sensor 104 and is received through a return lens 309 that provides a desired return or receiving field of view FOV_{REC} for the sensor 104, as described above with reference to FIG. 2. The return lens 309 in this way is used to control the field of view FOV_{REC} of the sensor 104. The return lens 309 directs the return optical pulse signal 306 to range estimation circuitry 310 for estimating the imaging distance D_{TOF} between time-of-flight sensor 104 and the hand 308. The return lens 309 is an optional component and thus some embodiments of the time-of-flight sensor 104 do not include the return lens.

In the embodiment of FIG. 3, the range estimation circuitry 310 includes a return single-photon avalanche diode (SPAD) array 312, which receives the returned optical pulse signal 306 via the lens 309. The SPAD array 312 corresponds to the return array 214 of FIG. 2 and typically includes a large number of SPAD cells (not shown), each cell including a SPAD for sensing a photon of the return optical pulse signal 306. In some embodiments of the time-of-flight sensor 104, the lens 309 directs reflected optical pulse signals 306 from separate spatial zones within the field of view FOV_{REC} of the sensor to certain groups of SPAD cells or zones of SPAD cells in the return SPAD array 312, as will be described in more detail below.

Each SPAD cell in the return SPAD array 312 provides an output pulse or SPAD event when a photon in the form of the return optical pulse signal 306 is detected by that cell in the return SPAD array. A delay detection circuit 314 in the range estimation circuitry 310 determines a delay time between transmission of the transmitted optical pulse signal 302 as sensed by a reference SPAD array 316 and a SPAD event detected by the return SPAD array 312. The reference SPAD array 316 is discussed in more detail below. The SPAD event detected by the return SPAD array 312 corresponds to receipt of the return optical pulse signal 306 at the return SPAD array. In this way, by detecting these SPAD events, the delay detection circuit 314 estimates an arrival time of the return optical pulse signal 306. The delay detection circuit 314 then determines the time of flight TOF based upon the difference between the transmission time of the transmitted optical pulse signal 302 and the arrival time of the return optical pulse signal 306 as sensed by the SPAD array 312. From the determined time of flight TOF, the delay detection circuit 314 generates the range estimation signal RE (FIG. 1) indicating the detected distance D_{TOF} between the hand 308 and the time-of-flight sensor 104.

The reference SPAD array 316 senses the transmission of the transmitted optical pulse signal 302 generated by the light source 300 and generates a transmission signal TR indicating detection of transmission of the transmitted optical pulse signal. The reference SPAD array 316 receives an internal reflection 318 from the lens 304 of a portion of the transmitted optical pulse signal 302 upon transmission of the transmitted optical pulse signal from the light source 300, as discussed for the reference array 210 of FIG. 2. The lenses 304 and 309 in the embodiment of FIG. 3 may be considered to be part of the glass cover 206 or may be internal to the package 213 of FIG. 2. The reference SPAD array 316 effectively receives the internal reflection 318 of the transmitted optical pulse signal 302 at the same time the transmitted optical pulse signal is transmitted. In response to this received internal reflection 318, the reference SPAD array 316 generates a corresponding SPAD event and in response thereto the transmission signal TR indicating the transmission of the transmitted optical pulse signal 302.

The delay detection circuit 314 includes suitable circuitry, such as time-to-digital converters or time-to-analog converters, to determine the time-of-flight TOF between the transmission of the transmitted optical pulse signal 302 and receipt of the reflected or return optical pulse signal 308. The delay detection circuit 314 then utilizes this determined time-of-flight TOF to determine the distance D_{TOF} between the hand 308 and the time-of-flight sensor 104. The range estimation circuitry 310 further includes a laser modulation circuit 320 that drives the light source 300. The delay detection circuit 314 generates a laser control signal LC that is applied to the laser modulation circuit 320 to control activation of the laser 300 and thereby control transmission of the transmitted optical pulse signal 302. The range estimation circuitry 310 also determines the signal amplitude SA based upon the SPAD events detected by the return SPAD array 312. The signal amplitude SA is related to the number of photons of the return optical pulse signal 306 received by the return SPAD array 312. The closer the object 308 is to the TOF ranging sensor 104 the greater the sensed signal amplitude SA, and, conversely, the farther away the object the smaller the sensed signal amplitude.

FIG. 4A illustrates the time-of-flight sensor 104 of FIG. 1 positioned on the back side of the electronic device 100 according to one embodiment of the present disclosure. In this embodiment, the electronic device 100 is a smart phone and the time-of-flight sensor 104 is positioned on a back surface or side of the smart phone as shown in the figure. The back side is opposite the front side of the device, which is the side on which the touch screen 106 is positioned. In the embodiment of FIG. 4A, the time-of-flight sensor 104 is positioned proximate other components of the image capture circuitry 116 contained in the smart phone 100. For example, an aperture 400 of a digital camera is shown proximate the time-of-flight sensor 104 and a flash device 402 of the camera is also shown. Some smart phones and other types of mobile devices containing digital or video cameras may already include a time-of-flight sensor for use in an auto focusing system of these cameras. In this situation, the existing time-of-flight sensor 104 may also be used to detect input gestures according to embodiments of the present disclosure, as will be described in more detail below.

In one embodiment, the time-of-flight sensor 104 is used as a virtual button to allow the user to control the mobile device. If the mobile device includes a digital camera, the rear facing time-of-flight sensor can be used to activate a front facing camera to capture selfie images. For example, where the user is taking a selfie the user extends his or her arm away from themselves and then performs an up/down or tap input gesture by placing his or her finger at a distance over the sensor 104 and then moving the finger downward to touch the sensor, and then back upward again. The touch/gesture controller 102 (FIG. 1) processes the range estimation signal RE generated by the time-of-flight sensor 104 in response to the tap input gesture to thereby detect the tap input gesture. The touch/gesture controller 102 then provides information indicating the detection of a tap input gesture to the processing circuitry 112 which, in turn, controls the image capture circuitry 116 to capture an image.

The time-of-flight sensor 104 could of course be used to detect other types of input gestures to activate the image capture circuitry 116 to capture a selfie or standard digital image. The touch/gesture controller 102 processes the range estimation signal RE from the time-of-flight sensor 104 to detect the desired type of input gestures, as described in more detail below. As mentioned above, the control circuitry for processing the range estimation signal RE or signals from the time-of-flight sensor 104 over time may be contained or implemented in either the touch/gesture controller 102 or the processing circuitry 112, or in both.

FIG. 4B illustrates the time-of-flight sensor 104 positioned along an edge on a front surface of the electronic device 100 where the electronic device is a wearable device, such as a smart watch. Wearable devices may have relatively small displays, making utilization of a touch screen with the small display impractical or difficult for a user. The use of the time-of-flight sensor 104 allows a user to provide input gestures to control the wearable device 100 without a conventional capacitive, resistive or other type of touch screen. In addition, the utilization of the time-of-flight sensor 104 also enables a user to provide input gestures to the wearable device 100 while wearing a glove, which is not available for conventional capacitive based touchscreens without incorporating a special feature in the glove.

FIGS. 5A and 5B illustrate a user's hand 500 and a finger 502 of the hand providing an input gesture to the time-of-flight sensor 104 in the embodiments of FIGS. 4A and 4B, respectively. In this way, the user utilizes his or her finger 502 to provide input gestures to control the operation of the corresponding electronic device 100. The time-of-flight sensor 104 could also be positioned in locations of the electronic device 100 other than those illustrated in FIGS. 4A, 4B, 5A and 5B. For example, the time-of-flight sensor 104 could be positioned on an edge of the electronic device 110, where an edge is a surface of the device extending between the front and back sides of the device. An example of the time-of-flight sensor 104 positioned on a side edge of the electronic device 100 is shown in dashed lines in FIG. 4A, and other locations on edges as well as on the front and back sides device may be utilized.

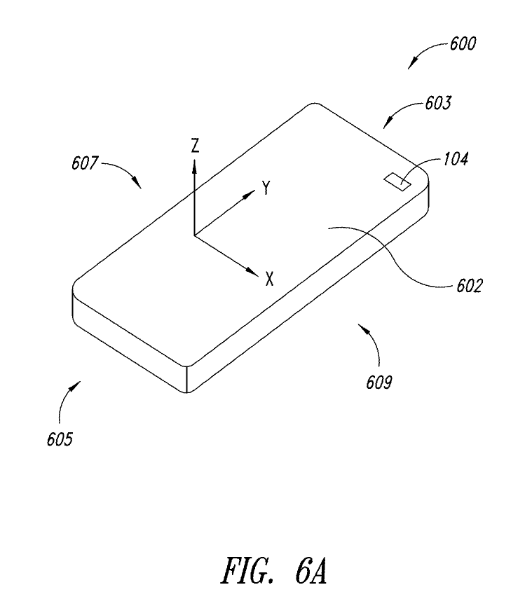

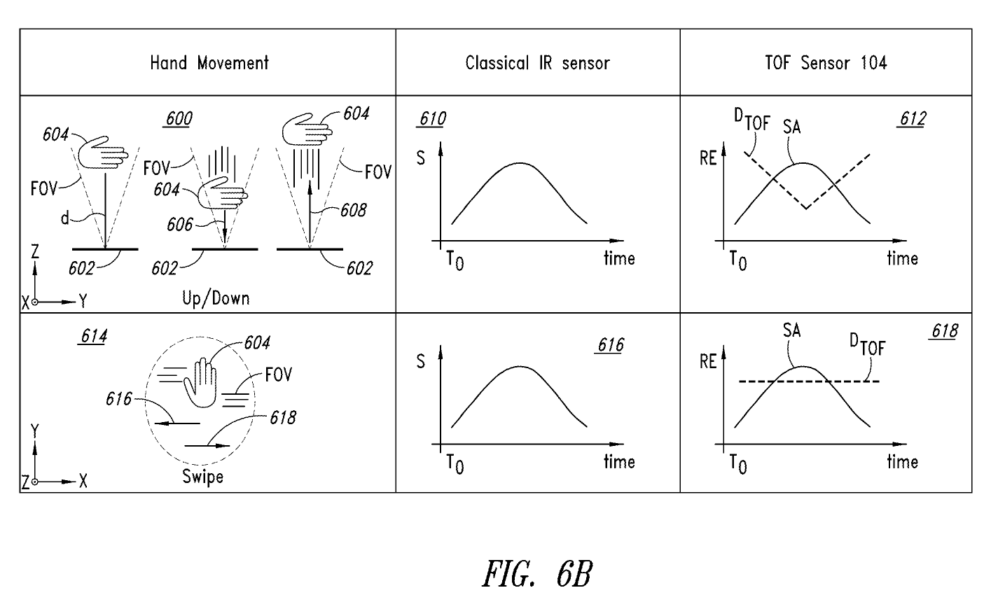

FIG. 6A is a perspective view of an electronic device 600 including the time-of-flight sensor 104 and illustrating a frame of reference relative to the time-of-flight sensor. The electronic device 600 if one embodiment of the electronic device 100 of FIG. 1 and is a smart phone in the example of FIG. 6A. The time-of-flight sensor 104 is positioned on a back side or surface 602 of the electronic device 600. A Cartesian coordinate system is shown where the back surface 602 is in the XY-plane and the Z-axis accordingly extends orthogonal to the back surface. A top edge 603, a bottom edge 605, a left edge 607 and a right edge 609 of the device 600 are shown. Input gesture movement from left-to-right or right-to-left is movement between the left and right edges 607, 609 parallel to the X-axis. Input gesture movement to top-to-bottom or bottom-to-top is movement between the top and bottom edges 603 and 605 parallel to the Y-axis. Finally, input gestures movement parallel to the Z-axis (i.e., orthogonal to the back surface 602) is movement “down” or towards the back surface and movement “up” or away from the back surface parallel to the Z-axis. The time-of-flight sensor 104 may be utilized to detect a variety of different types of input gestures, as will now be described in more detail with reference to this Cartesian coordinate system and FIG. 6A and with reference to FIG. 6B.

FIG. 6B is an array of subfigures or representations illustrating input gestures and the range estimation signal RE provided by the time-of-flight sensor 104 in one embodiment of the present disclosure. More specifically, the figure shows the range estimation signal RE generated by the time-of-flight sensor 104 in response to an up/down input gesture and in response to a swipe input gesture, and also shows the signals generated by a conventional infrared (IR) sensor, which may be used to detect distance, in response to the same up/down and swipe input gestures.

The upper leftmost column of FIG. 6B includes a representation 601 of an up/down input gesture. The representation 601 is a side view along the X-axis of the back surface 602 of the electronic device 600 on which the time-of-flight sensor is located. To perform an up/down input gesture, a hand 604 of a user is initially positioned over or spaced away from the back surface 602 and within the field of view FOV of the sensor 104 positioned on the back surface. The field of view FOV represents the overall field of view of the time-of-flight sensor 104 and thus includes the transmitting field of view FOV_{TR} and receiving field of view FOV_{REC} discussed above with reference to FIG. 2. An up/down input gesture involves the user initially positioning his or her hand 604 at a relatively large distance d over the surface 602 as shown in the leftmost figure of the representation 601. The back surface 602 is in the XY-plane and thus the hand 604 is positioned at the distance d along an axis parallel to the Z-axis extending orthogonal to the surface 602.

A complete up/down input gesture is movement parallel to the Z-axis down or towards the surface 602 from the distance d to some minimum distance and then movement up or away from the back surface and again parallel to the Z-axis. Thus, after the user has positioned his or her hand at the distance d over the back surface 602, the user then moves his or her hand down from the distance d parallel to the Z-axis towards the back surface 602 as indicated by an arrow 606. The distance d of the hand 604 from the back surface 602 accordingly becomes smaller until the distance reaches some minimum value. The user then moves his or her hand 604 up from the minimum distance parallel to the Z-axis and away from the back surface 602 as indicated by an arrow 608 so that the distance d of the hand from the surface increases. This upward movement of the hand 604 completes the up/down input gesture.

A representation 610 in the upper row and middle column of FIG. 6B shows the amplitude of a signal S generated as a function of time by a conventional IR sensor in response to the up/down input gesture. The signal S is shown as starting at a time T0, which corresponds to the initial situation in representation 601 where the hand is positioned an orthogonal distance d from the back surface 602. The signal S then starts increasing as the hand 604 moves downward parallel to the Z-axis and towards the back surface 602 as indicated by arrow 606 in representation 601. The signal S reaches a peak at which point the hand 604 is at a minimum distance from the surface 602. The signal S then decreases from the peak value as the hand 604 starts moving upward parallel to Z-axis and away from the back surface 602 as indicated by arrow 608 in the representation 601. The distance d of the hand 604 from the back surface 602 is inversely proportional to the amplitude of the signal S in the representation 610, as will be appreciated by those skilled in the art.

A representation 612 in the upper row and rightmost column of FIG. 6B shows the range estimation signal RE generated by the time-of-flight sensor 104 over time in response to the up/down input gesture of representation 601. The range estimation signal RE includes the signal amplitude SA indicating the amplitude of the return optical pulse signal 306 (FIG. 3) and the detected distance D_{TOF} between time-of-flight sensor 104 and the hand 604 in response to the up/down input gesture. The range estimation signal RE again starts at a time T0 and the detected signal amplitude SA and distance D_{TOF} vary as shown over time in response to the up/down input gesture. Again, as the hand 604 moves from the distance d down towards the surface 602 and then back upward the signal amplitude SA has a similar shape to the signal S generated by the conventional IR sensor as shown in representation 610. The signal amplitude SA is related to the number of photons of the return optical pulse signal 306 (FIG. 3) received by the time-of-flight sensor 104, and thus the closer the hand 604 to the back surface 602 (i.e., the smaller the distance d along the Z axis) the larger the sensed signal amplitude SA. This is also seen in the value of the sensed distance D_{TOF} detected by the sensor 104, with the signal amplitude SA having the maximum value when the sensed distance has a minimum value. In comparing representation 612 to representation 610, the signal amplitudes S and SA have similar shapes or patterns over time for the conventional IR sensor and time-of-flight sensor 104, but the time-of-flight sensor also provides the sensed distance D_{TOF} over time, which is used to distinguish between up/down input gestures and swipe input gestures, as will be explained more detail below.

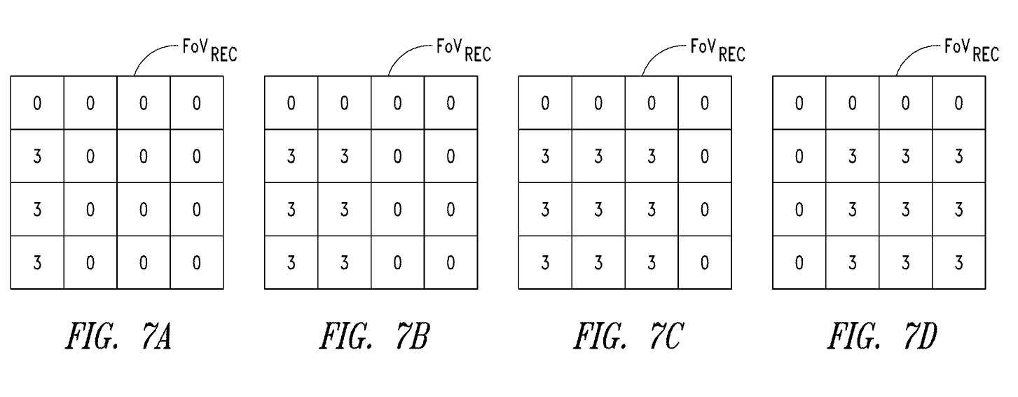

The bottom row in the leftmost column of FIG. 6B includes a representation 614 showing a top view of a swipe input gesture. The representation 614 is a top view shown looking down on the back surface 602 along the Z-axis (see FIG. 6A). Thus, in the representation 614, the back surface 602 containing the time-of-flight sensor 104 is below the user's hand 604 positioned over or spaced away from this surface at a distance d from the surface. To perform a swipe input gesture, the user positions his or her hand at a distance d over or spaced away from the back surface 602 on which the sensor 104 is positioned, and within the field of view FOV of the sensor. The user then moves his or her hand 604 either to the left as indicated by an arrow 616 or to the right as indicated by an arrow 618 through the field of view FOV. During this movement, the user maintains the hand 604 over or spaced away from and at a relatively constant distance d from the back surface 602. Thus, the user moves his or her hand 604 parallel to the X-axis in either the positive direction (i.e., to the right as indicated by arrow 618) or in the negative direction (i.e., to the left as indicated by arrow 616) to perform a swipe gesture. The hand 604 passes through the field of view FOV of the sensor 104 positioned on the surface 602 as the hand is moved to the left 616 or to the right 618. The swipe input gesture could alternatively be performed by movement of the user's hand 604 along the Y-axis instead of the X-axis. Where the time-of-flight sensor 104 is a multiple zone sensor, a swipe input gesture along the X-axis or the Y-axis may be distinguished, as will be described in more detail with reference to FIG. 7.

A representation 616 in the lower row and middle column shows the amplitude of the signal S generated as a function of time by a conventional IR sensor in response to the swipe input gesture of the representation 614. The signal S in representation 616 is the same as the signal S in representation 610 generated in response to the up/down input gesture. More specifically, the signal S again starts at a time T0 and starts increasing as the hand 604 moves leftward over the surface 602 as indicated by arrow 616 and passes through the field of view of the sensor. The signal S reaches a peak at which point the hand 604 is directly over the field of view of the sensor and then decreases from the peak value as the hand moves out of the field of view of the sensor. In comparing representation 616 to representation 610, it is seen that the signal S generated by a conventional IR sensor is the same for both the up/down input gesture and the swipe input gesture. Thus, these two input gestures cannot be distinguished with a conventional IR sensor.

Finally, a representation 618 in the lower rightmost column of FIG. 6B shows the range estimation signal RE generated by the time-of-flight sensor 104 over time in response to the swipe input gesture. The range estimation signal RE again starts at a time T0 and the detected signal amplitude SA and distance D_{TOF} vary as shown over time in response to the swipe input gesture. In comparing representation 618 to representation 616, the signal amplitudes S and SA have the same pattern over time for the conventional IR sensor and time-of-flight sensor 104, but the time-of-flight sensor also provides the sensed distance D_{TOF} which is used to distinguish between a swipe input gesture and an up/down input gesture, as will now be explained in more detail.

To detect whether an input gesture is an up/down input gesture or a swipe input gesture, the touch/gesture controller 102 (FIG. 1) determines whether the range estimation signal RE has the pattern of representation 612 or the pattern of representation 618. More specifically, when the signal amplitude SA of the range estimation signal RE has the pattern of representations 612 and 618, the controller determines whether the sensed distance D_{TOF} is relatively constant as in representation 618 or varies as shown in representation 612. If the sensed distance D_{TOF} is relatively constant, the touch/gesture controller 102 determines the input gesture is a swipe input gesture since the patterns of the signal amplitude SA and sensed distance D_{TOF} correspond to representation 618. Conversely, if the sensed distance D_{TOF} varies as shown in representation 612, the touch/gesture controller 102 determines the input gesture is an up/down input gesture since the patterns of the signal amplitude SA and sensed distance D_{TOF} correspond to representation 612. In this way, the utilization of the time-of-flight sensor 104 and the range estimation signal RE generated by that sensor enables the touch/gesture controller 102 two distinguish between up/down and swipe input gestures, which is not possible with conventional IR sensors.

FIGS. 7A-7D illustrates the concept of multiple fields of view FOV or multiple zones utilized in some embodiment of the time-of-flight sensor 104 of FIGS. 1-3 to sense some of types of input gestures. In FIGS. 7A-7D, the overall large square represents the receiving field-of-view FOV_{REC} of the time-of-flight sensor 104 as discussed above with reference to FIG. 2. Where the time-of-flight sensor 104 is a multiple zone sensor as illustrated in FIGS. 7A-7B, however, the receiving field of view FOV_{REC} includes a number of separate spatial zones or independent subfields of view within the receiving field of view. In the example of FIGS. 7A-7D, the receiving field of view FOV_{REC} includes sixteen separate spatial zones or subfields of view. The time-of-flight sensor 104 may include different numbers of subfields of view FOV in other embodiments, such as four zones, nine zones, or any number of zones more than two.

When the time-of-flight sensor 104 senses objects in multiple independent zones or fields of view as shown in FIG. 7, the lens 309 (FIG. 3) is formed to direct reflected optical pulse signals 306 from separate spatial zones within the field of view FOV_{REC} of the sensor 104 to corresponding groups or zones of SPAD cells in the return SPAD array 312. Alternatively, multiple lenses and multiple return SPAD arrays 312 could be utilized. Each group or zone of SPAD cells in the return SPAD array 312 generates a corresponding range estimation signal RE and thus the multi zone time-of-flight sensor 104 generates multiple range estimation signals.

Referring to FIGS. 2, 3 and 7, the overall operation of such a multiple zone time-of-flight sensor 104 will now be described in more detail. In operation, the light source 200 illuminates or transmits the transmitted optical pulse signal 302 into the transmission field of view FOV_{TR} and return optical pulse signals 306 corresponding to portions of the transmitted optical pulse signal reflect off an object within the transmission field of view and are back to the sensor 104. The return optical pulse signals 306 within the receiving field of view FOV_{REC} are received by the return SPAD array 316. More specifically, return optical pulse signals 306 within each of the sixteen subfields of view are received by corresponding groups or zones of SPAD cells in the return SPAD array 316. The outputs provided by SPAD cells in the different regions of the return SPAD array 312 each generate a corresponding range estimation signal RE for the associated subfield of view FOV of the multi zone time-of-flight sensor 104. The multiple range estimation signals RE thus indicate where a user's hand is in relation to each field of view. The touch/gesture controller 102 utilizes the range estimation signals RE provided from all the regions or zones of the return SPAD array 312, taken at successive points in time, to determine the course of the hand or other object passing through the multiple subfields of view. This is illustrated in FIGS. 7A-7D. In each of these figures, each of the subfields of view or zones has either a zero (0) or a three (3) inserted in that zone. These numbers represent the range estimation signal RE generated for each zone. A zero for the range estimation signal RE in a given zone indicates no object is detected in that zone. Conversely, the number three for the range estimation signal RE indicates an object has been detected for that zone, with the magnitude of the range estimation signal indicating a distance of the detected object within the zone.

The example of FIGS. 7A-7D illustrates an example of a swipe input gesture moving from left to right across the zones over time starting in FIG. 7A and ending in FIG. 7D. In this description, the rows of zones are referred to as rows 1-4 from the top to bottom and the columns referred to as columns 1-4 from left to right in these figures. In FIG. 7A, the user's hand is first detected at a first point in time within the zones in column 1, rows 2-4. As a result, the zones in column 1, rows 2-4 include a 3 for the range estimation signal RE. FIG. 7B shows the sensed values for the range estimation signals RE for each of the zones at a later point in time. In this example, the user's hand has continued moving from left to right through the zones so that now the range estimation signals for the zones in both columns 1 and 2 and rows 2-4 have values of 3. A swipe gesture occurs at a relatively constant distance from the time-of-flight sensor 104 (see representation 618 in FIG. 6B) and thus the magnitudes for all zones in which the user's hand is detected have values of 3.

FIG. 7C shows the sensed values for the range estimation signals RE for each of the zones at a still later point in time. The user's hand has accordingly continued moving from left to right through the zones so that now the range estimation signals for the zones in columns 1-3 and rows 2-4 have values of 3. The magnitudes for all zones in which the user's hand is detected have values of 3 for the swipe gesture. Finally, in FIG. 7D the user's hand has continued moving from left to right through the zones so that now the range estimation signals for the zones in columns 2-4 and rows have values of 3. Thus, at this point the user's hand has move rightward to the extent that the hand is no longer present in the zones column 1. Once again, the magnitudes for all the zones in which the user's hand is detected have values of 3, which is would be the case for a swipe gesture occurring at a relatively constant distance from the time-of-flight sensor 104.

The touch/gesture controller 102 is configured to process these multiple range estimation signals RE from the multiple zones or subfields of view over time to recognize specific input gestures that may be detected by the time-of-flight sensor 104, as will be appreciated by those skilled in the art. Such a multi zone time-of-flight sensor 104 may be utilized to detect a variety of different types of input gestures. Also note that as will be evident from the example of FIGS. 7A-7D, the touch/gesture controller 102 can distinguish between swipe gestures occurring along the X axis or the Y axis as previously discussed with reference to the representation 614 of FIG. 6B. FIGS. 7A-7B illustrate a left-to-right swipe input gesture occurring along the X axis. This left-to-right swipe input gesture along the X axis can be distinguished from a right-to-left swipe input gesture along the X axis based on the range estimation signals RE generated by the time-of-flight sensor 104. In the right-to-left swipe input gesture along the X axis, the zones in which the hand is detected would be the opposite of that in FIGS. 7A-7D, with the hand first being detected in column 4, rows 2-4 and then propagating in the same way to column 1. Similarly, a swipe input gesture occurring along the Y axis can be distinguished from swipe input gestures occurring along the X axis. Swipe input gestures along the Y axis would result in the detected object propagating through the rows of zones in a manner analogous to that for propagation thorough the columns of zones illustrated in FIGS. 7A-7D, as will be understood by those skilled in the art in view of the present description.

Some input gestures require the time-of-flight sensor 104 be a multi zone sensor while other input gestures can be detected through a time-of-flight sensor having only a single zone or field of view. In addition to the up/down and swipe input gestures discussed above with reference to FIG. 6B, other input gestures such as a double swipe gesture may also be detected. A double swipe is where the user's hand moves from left to right, or right to left, across the fields of view and then back across the fields of view in the opposite direction. In some embodiments, the time-of-flight sensor 104 may be viewed as a “virtual button” on the electronic device 100 containing the sensor. A user could in this situation provide a “block” input gesture where the user places his or her finger on the sensor to cover or “block” all the fields of view of the time-of-flight sensor 104. In addition to the up/down or “tap” gesture described above with reference to FIG. 6B, a double tap gesture could also be detected where the up/down movement of the user's hand in performed twice. Although an up/down input gesture is shown in FIG. 6B and described as involving a user's hand 604, such an up/down input gesture could alternatively involve only a finger of the user's hand. In this situation, one of the user's fingers would perform the motion discussed with reference to the representation 601 of FIG. 6B. The time-of-flight sensor 104 could again be viewed as a “virtual button” in this situation, with each up/down gesture being performed by a user's finger to effectively “press” the virtual button, with associated functionality then being performed such as capturing an image in response to the virtual button being pressed.

In operation, the touch/gesture controller 102 processes the one or more range estimation signals RE from the time-of-flight sensor 104 to detect the various types of input gestures that may be detected by the electronic device 100. The touch/gesture controller 102 then provides this detected gesture information to the processing circuitry 112. The apps 114 executing on the processing circuitry 112 then operate based on functionality assigned to each of the recognized input gestures. For example, the swipe gesture could move from one page in a document to the next, or to a next song or prior song if associated with a music app 114. The block input gesture could be associated with a pause function or a hold function when the app 114 is a music or video app, while the double tap could be associated with start/stop control within apps. As mentioned above, recognition of some input gestures requires the time-of-flight sensor 104 be a multi zone sensor. For example, to sense swipe input gestures and double swipe input gestures, the time-of-flight sensor 104 must be a multi-zone sensor.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited to the present disclosure.

1. A device, comprising:
a time-of-flight sensor configured to transmit an optical pulse signal and to receive a return optical pulse signal corresponding to a portion of the transmitted optical pulse signal that has reflected off an object within a field of view of the time-of-flight sensor, the time-of-flight sensor configured to generate a range estimation signal including a distance to the object and a signal amplitude indicating an amplitude of the return optical pulse signal; and
a controller coupled to the time of flight sensor, the controller configured to process the range estimation signal over time to detect an input gesture based upon the signal amplitude and the distance.

2. The device of claim 1, wherein the controller is further configured to control operation of the electronic device in response to the detected input gesture.

3. The device of claim 2 further comprising image capture circuitry, the controller configured to control operation of the image capture circuitry responsive to the detected input gesture.

4. The device of claim 1, wherein the time-of-flight sensor comprises:
a light source configured to generate the transmitted optical pulse signal; and
a return array including a plurality of light sensors, the return array configured to detect the return optical pulse signal.

5. The device of claim 4, wherein the return array comprises a plurality of zones, each zone including a plurality of light sensors having a subfield of view within the field of view of the time-of-flight sensor and the time-of-flight sensor configured to generate a respective range estimation signal for each zone of the return array.

6. The device of claim 5, wherein the return array comprises a single-photon avalanche diode array.

7. The device of claim 5, wherein the controller is configured to sense up/down gestures and swipe input gestures based upon the plurality of range estimation signals generated by the plurality of zones of the return array.

8. The control circuit of claim 1, wherein the controller comprises at least one of a gesture controller and processing circuitry.

9. An electronic device, comprising:
a touch screen including a touch display and a touch panel, the touch screen being positioned on a front side of the electronic device;
a time-of-flight sensor positioned on a back side of the electronic device opposite the front side, the time-of-flight sensor configured to generate a range estimation signal including a distance to the object and a signal amplitude indicating an amplitude of the return optical pulse signal;
image capture circuitry configured to capture images of an object being imaged, the image capture circuitry configured to capture images from both the front side and the back side of the electronic device; and
a controller coupled to the touch screen, time-of-flight sensor and image capture circuitry, the controller configured to process the range estimation signal over time to detect an input gesture based upon the signal amplitude and the distance and to control the image capture circuitry to capture an image from the front side of the electronic device in the response to the input gesture.

10. The electronic device of claim 9, wherein the image capture circuitry further comprises an autofocus subsystem configured to focus the image capture circuitry on an object being imaged based upon the distance from the time-of-flight sensor.

11. The electronic device of claim 9, wherein the image capture circuitry comprises an aperture and a flash device positioned on the back side of the electronic device proximate the time-of-flight sensor.

12. The electronic device of claim 9, wherein the electronic device is a smart phone.

13. The electronic device of claim 10, wherein the input gesture is a tap gesture.

14. The electronic device of claim 9, wherein the time-of-flight sensor comprises:
a light source configured to generate the transmitted optical pulse signal; and
a return array including a plurality of light sensors, the return array configured to detect the return optical pulse signal.

15. The electronic device of claim 14, wherein the return array comprises a plurality of zones, each zone including a plurality of light sensors having a subfield of view within the field of view of the time-of-flight sensor and the time-of-flight sensor configured to generate a respective range estimation signal for each zone of the return array.

16. The control circuit of claim 15, wherein the controller is configured to sense up/down gestures and swipe input gestures based upon the plurality of range estimation signals generated by the plurality of zones of the return array.

17. A method, comprising:
transmitting an optical pulse signal;
generating a transmission signal indicating transmission of the optical pulse signal;
receiving a return optical pulse signal corresponding to a portion of the transmitted optical pulse signal reflected off an object;
generating a range estimation signal based upon a time difference between the transmission signal indicating transmission of the optical pulse signal and receipt of the return optical pulse signal, the range estimation signal including a distance to the object and a signal amplitude indicating an amplitude of the return optical pulse signal; and
processing the range estimation signal over time to detect an input gesture based upon the signal amplitude and the distance.

18. The method of claim 17 further comprising controlling the electronic device in response to the detected input gesture.

19. The method of claim 17, wherein receiving the return optical pulse signal comprises receiving the return optical pulse signal from a plurality of spatial zones within a field of view, and wherein generating the range estimation signal comprises generating a respective range estimation signal for each of the plurality of spatial zones.

20. The method of claim 17, wherein processing the range estimation signal over time to detect the input gesture comprises processing the range estimation signal over time to detect whether the input gesture is one of a tap, double tap, swipe, double swipe, or blocking gesture.
